(19) United States
(12) Patent Application Publication
(10) Pub. No.: US 2008/0198438 A1
(43) Pub. Date: Aug. 21, 2008

(54) Optical Element

(75) Inventors: Stein Kuiper, Vught (NL); Bernardus H.W. Hendriks, Eindhoven (NL); Michiel J.M. Van Der Aa, Sint Michelsgestel (NL); Johannes J.H.B. Schleipen, Eindhoven (NL); Helmar Van Santen, Amsterdam (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,763

(22) PCT Filed: May 27, 2005
(86) PCT No.: PCT/IB05/51738

§ 371 Date: Oct. 19, 2007

(30) Foreign Application Priority Data
Jun. 1, 2004 (EP) 04102437.3
Nov. 5, 2004 (GB) 0424451.3

(51) Int. Cl. G02F 1/09

(52) U.S. Cl. 359/280

(57) ABSTRACT

An optical element comprises a fluid chamber, the fluid chamber having side and end walls, and contains a first fluid (20) and a second fluid (22). The fluids are non-miscible and the second fluid is capable of being influenced by a magnetic field. A device (19) for providing a magnetic field over at least a portion of the fluid chamber is provided, with the magnetic field being capable of moving the second fluid so that the positions of the first an second fluids in the fluid chamber are altered. The second fluid may be a ferrofluid.

This invention relates to an optical element. Optical elements such as lenses, shutters and diaphragms are used in optical devices such as cameras.

The advent of cameras in mobile multimedia devices, such as the third generation mobile telephones, has increased the emphasis on providing optical elements that are lightweight and compact, while still providing good optical properties. To this end, so called variable electrowetting elements have been developed.

For example, U.S. Pat. No. 6,449,081 discloses an optical element and an optical device that uses the element. The optical element has a first fluid and an electroconductive or polar, second fluid, immiscible with each other, which are confined in a sealed space created between a first support and a second support. The first fluid and the second fluid have respective light transmittances different from each other. By varying a voltage applied to the second fluid, the shape of an interface between the first fluid and the second fluid is altered, so as to change an amount of light passing through the optical element.

This type of element is known as an electrowetting element, which has relatively low power consumption in normal operation, and a quick response to a varying voltage. However, the electrowetting element requires a large switching voltage to alter the shape of the interface between the two fluids, which limits the obtainable change in the shape of the interface.

Similarly, Japanese Patent Application Publication 2003-057411 discloses a variable focus lens that is able to change an optical path passing through two kinds of fluids and to vary the focus by enclosing two kinds of fluids having characteristics of sensing an electrical field and not sensing the electrical field in a transparent container, and applying the electrical field on them from outside and inclining the density distribution of each fluid. The electrical field sensitive fluid and the electrical field non-sensitive fluid are packed inside the lens body. The electrical field is applied on them from outside by a power source through an electrode and an electrode. Then, the inclination is generated in the density distribution of both fluids.

Likewise, the type of lens described in this publication is also an electrowetting lens, which again has relatively low power consumption in normal operation, and a quick response to a varying voltage. However, the electrowetting lens still has the problem that it requires a large switching voltage to alter the relationship between the two fluids, which limits the obtainable change in the interface shape relationship between the two fluids.

It is an object of the invention to improve upon the known art.

According to a first aspect of the present invention, there is provided an optical element comprising a fluid chamber, the fluid chamber having side is walls and end walls, and containing a first fluid and a second fluid, the fluids being non-miscible and the second fluid being capable of being influenced by a magnetic field, and a device for providing a magnetic field over at least a portion of the fluid chamber, the magnetic field capable of moving the second fluid so that the positions of, and/or the shape of the interface between, the first and second fluids in the fluid chamber are altered.

Owing to the invention it is possible to provide an optical element in which it is possible to move the fluids in the fluid chamber to change the optical characteristics of the device. This movement of the fluids may simply be to move the fluids so that the contacting surface between them changes, or it may be to change the actual locations of the fluids within the fluid chamber.

In one preferred embodiment, the fluid chamber further contains a third fluid. A wide variety of possible constructions of the fluid chamber are possible, and in some embodiments it is preferable to use a third fluid. This may be because the second fluid, which is the fluid that is moved by the magnetic field is non-transparent, and the first and third fluids are used along the axis through which light will travel in the optical element. In this case the first and third fluids will be transparent.

Advantageously, all of the contact surface between any two different fluids in the fluid chamber forms a meniscus. The fluids, where they are in contact, form a meniscus, which gives the optical device its optical characteristics. In some embodiments, at least one fluid contained in the fluid chamber has two menisci. This results when a fluid contacts two other fluids or if the fluid chamber is so constructed that there are multiple contact surfaces between two different fluids.

Preferably, the fluid chamber comprises a main chamber and a side chamber, with the side chamber being connected to the main chamber at each end of the main chamber. The use of a side chamber in the fluid chamber simplifies the construction of the overall optical element, because the device for producing a magnetic field can be placed to work in relation to the side chamber.

Ideally, the device for providing a magnetic field over at least a portion of the fluid chamber comprises a voltage source for generating a gradient magnetic field, and the device for providing a magnetic field also includes a single coil or a pair of coils. If there is a single coil then this is advantageously placed so that it is around the side chamber of the fluid chamber, and likewise, if there is a pair of coils, then preferably, at least one of the pair of coils is placed around the side chamber of the fluid chamber.

In one embodiment, the side walls of the fluid chamber are so shaped that the fluid chamber comprises a substantially cylindrical shape, and in another embodiment the side walls of the fluid chamber are so shaped that the fluid chamber comprises a substantially frustum shape.

Preferably, the second fluid is a ferrofluid. In one embodiment, the first fluid and the second fluid are transparent, and in a second embodiment the first fluid is transparent and the second fluid is non-transparent.

Advantageously, at least a portion of the internal surface of the fluid chamber is provided with a hydrophobic insulator. This insulator is used to reduce hysteresis in the fluid chamber, as the hydrophobic insulator will encourage the movement of the meniscus.

The optical element is for use in devices such as an image capture device, such as a digital camera, or for use in an optical recording device such as CD recorder as used in devices such as computers.

Embodiments of the present invention will now be described, by way of example only, with reference to the accompanying drawings, in which:—

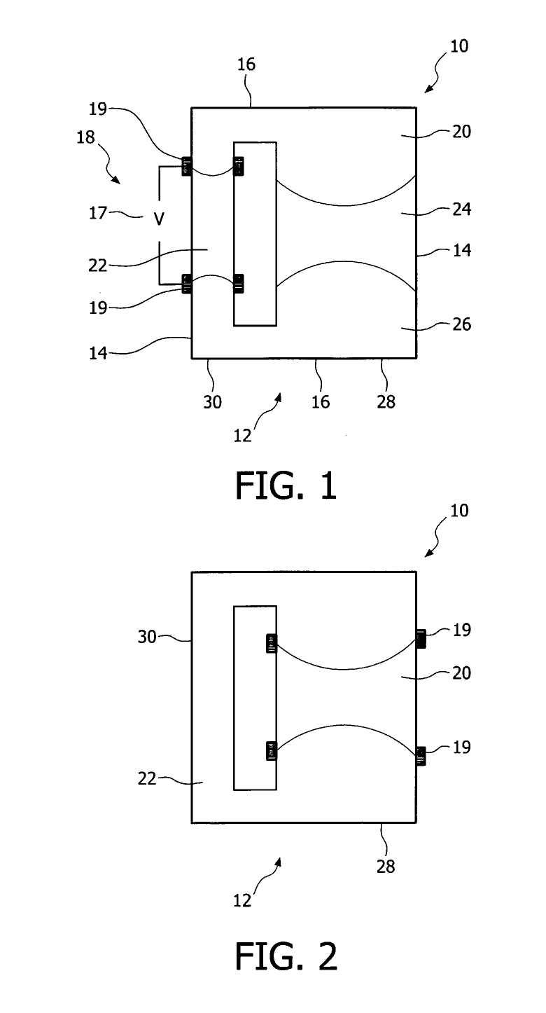

FIG. 1 is a schematic diagram of an optical element,

FIG. 2 is a schematic diagram of a second embodiment of the optical element,

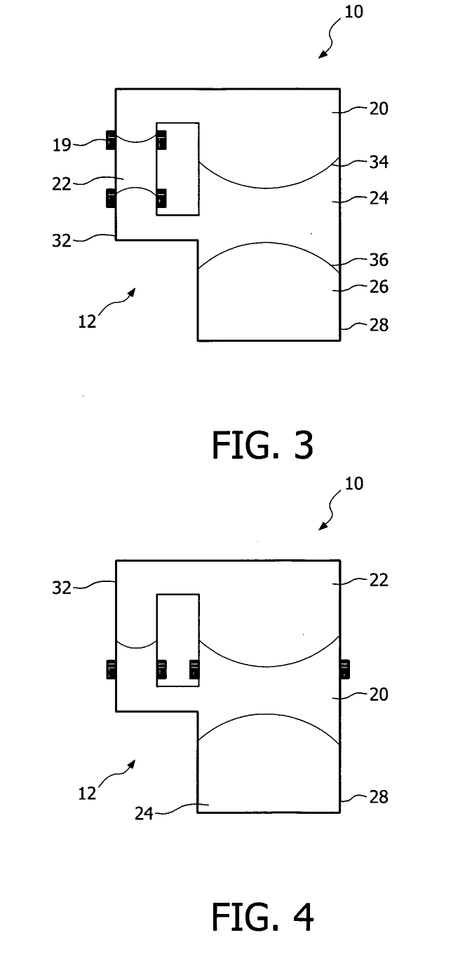

FIG. 3 is a schematic diagram of a third embodiment of the optical element,

FIG. 4 is a schematic diagram of a fourth embodiment of the optical element,

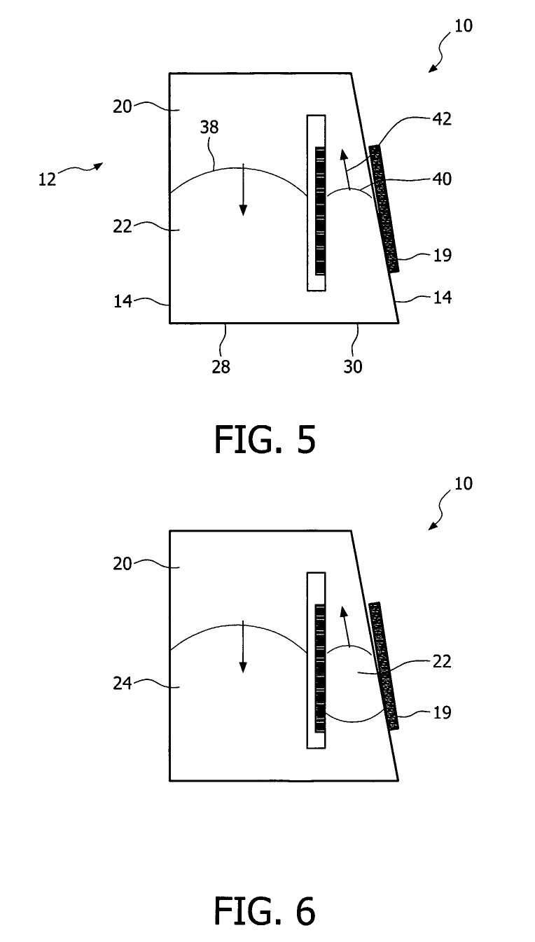

FIG. 5 is a schematic diagram of a fifth embodiment of the optical element,

FIG. 6 is a schematic diagram of a sixth embodiment of the optical element,

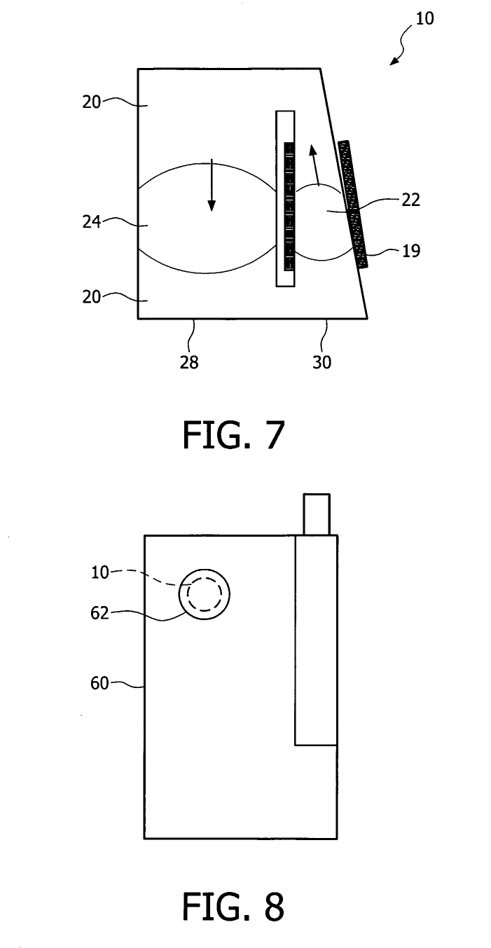

FIG. 7 is a schematic diagram of a seventh embodiment of the optical element, and

FIG. 8 is a schematic diagram of an image capture device incorporating an embodiment of the optical element.

In FIG. 1, the optical element 10 comprises a fluid chamber 12. The fluid chamber 12 has side walls 14 and end walls 16, and contains a number of non-miscible fluids. When the optical element 10 is in use, then any light entering the optical element 10 will do so at one of the ends 16, will pass through a path through one or more of the liquids, and will exit at the opposite end 16. The various fluids in the fluid chamber 12 are discussed in more detail below.

The optical element 10 also comprises a device 18 for providing a magnetic field over at least a portion of the fluid chamber 12. This device 18 for providing a magnetic field comprises a voltage source 17 for generating a gradient magnetic field, and also includes a pair of coils 19. When no voltage is being provided by the source 17, no magnetic field is present, but as the voltage is increased, a gradient magnetic field is provided.

The fluid chamber 12 contains a first fluid 20 and a second fluid 22, the second fluid 22 being capable of being influenced by a magnetic field. The magnetic field provided by the device 18 is capable of moving the second fluid 22 so that the positions of the first and second fluids 20 and 22 in the fluid chamber 12 are altered. The chamber 12 also contains a third fluid 24 and a fourth fluid 26. The four fluids in the chamber 12 combine to give the optical element 10 its variable optical characteristics.

All of the contact surfaces between any two different fluids in the fluid chamber 12 form a meniscus, and at least one fluid contained in the fluid chamber 12 has two menisci. In the example shown in FIG. 1, all of the fluids contact two other fluids, so all four fluids have two menisci.

The fluid chamber 12 comprises a main chamber 28 and a side chamber 30. The side chamber 30 is connected to the main chamber 28 at each end of the side chamber 30. The pair of coils 19 is located around the side chamber of the fluid chamber.

FIG. 2 shows a second embodiment of the optical element 10. As before, the optical element 10 comprises a fluid chamber 12, which has a main chamber 28 and a side chamber 30. In this respect, the embodiment of FIG. 2 is the same as that shown in FIG. 1. However the coils 19 that form part of the device 18 for providing a magnetic field over at least a portion of the fluid chamber 12 are placed around the main chamber 28, and the fluid chamber 12 contains only two fluids, a first fluid 20, and a second fluid (a ferrofluid) 22.

The optical element 10 can have its optical properties varied, by the use of the magnetic field that can be provided by the coils 19. As voltage is supplied to the coils 19, a gradient magnetic field is provided that will affect the ferrofluid 22 according to its properties. The ferrofluid 22 is moved by the magnetic field, which moves the two fluids in the chamber 12. This movement alters the position of the fluids in the chamber and therefore creates a new path for light through the chamber 12. As the voltage is increased, the ferrofluid 22 is affected further and moved further. The voltage can be reversed over the coils 19, causing the magnetic field to be reversed, and thereby reversing the movement of the ferrofluid 22.

FIG. 3 shows a further, third, embodiment of the optical element 10, with a fluid chamber 12 that is of a different form from that shown in the embodiments of FIGS. 1 and 2. The fluid chamber 12 is still provided with a main chamber 28 and a side chamber 32, but the side chamber 32 is smaller than that in the first two embodiments. The side chamber 32 is joined to the main chamber 28 of the fluid chamber 12 at one end of the main chamber 28 and at approximately the middle of the main chamber 28.

In the optical element 10 of FIG. 3, the coils 19 that form part of the device for generating the magnetic field are provided around the side chamber 32 of the fluid chamber 12. The fluid chamber 12 contains four different fluids, including the ferrofluid 22. The other three fluids 20, 24 and 26 are aligned in the main chamber 28 and provide the path through which light travels through the optical element 10.

The pairs of coils 19, when a voltage is applied, create a magnetic field over the side chamber 32 that is used to move the volume of ferrofluid 22. The movement of this fluid 22 causes a movement of the fluids 20 and 24. This results in the meniscus 34, which is the interface between the first fluid 20 and the third fluid 24, being moving closer or away from the nearest end wall. The meniscus 34 does not change shape in any way, but is controlled to move relative to the end of chamber, thereby affecting the optical path of any light passing through the fluid chamber 12. The meniscus 36, which is formed by the interface of the third fluid 24 and the fourth fluid 26 does not move or change shape, regardless of the movement of the fluids 20 and 24.

A fourth version of the optical element is illustrated in FIG. 4, which shows a fluid chamber 12 identical in construction to the fluid chamber 12 of FIG. 3. As in that embodiment, the main chamber 28 is connected to a shorter side chamber 32 that extends parallel to the main chamber 28, but only along a portion of the length of the main chamber 28. This embodiment of the optical device 10 has three fluids in the chamber 12 and has two pairs of coils 19, for generating the magnetic field.

The pairs of coils 19 however, are provided with one coil on each of the chambers 28 and 32, as can be seen in the Figure. The first fluid 20 lies in between the ferrofluid 22 and a third fluid 24. As before, the main chamber 28 is the part of the optical element 10 through which light will pass when the optical element 10 is in operation. The first fluid 20 and the second fluid 22 are transparent, as is the third fluid 24. The optical characteristics of the element 10 are changed by the provision of a magnetic field by the coils 19. The magnetic field will affect the second fluid 22 such that the meniscus 36 is moved in the chamber 12.

In all of the four embodiments shown in FIGS. 1 to 4, the side walls 14 of the fluid chamber 12 are so shaped that the fluid chamber 12 comprises a substantially cylindrical shape. The end walls 16 are substantially flat.

FIG. 5 shows a fifth embodiment of the optical element 10, in which the side walls 14 of the fluid chamber 12 are so shaped that the fluid chamber 12 comprises a substantially frustum shape. The fluid chamber 12 contains two fluids 20 and 22, being a first fluid 20, which is a transparent oil and a second fluid 22 being a transparent water-based ferrofluid 22. The two fluids 20 and 22 are immiscible. The fluid chamber 12 has a main chamber 28 and a side chamber 30, and a single coil 19 is provided around the side chamber 30. The side chamber 30 is joined to the main chamber 28 at each end of the side chamber 30.

The two fluids 20 and 22 form menisci at their contact surfaces. The meniscus 38 in the main chamber 28 of the fluid chamber 12 gives the optical element 10 its optical properties, and the changing of the position of this meniscus 38 changes the focusing or transmission of light through the element 10. The single coil 19 in the side chamber 30 is used to attract the ferrofluid 22 and Laplace pressure caused by the meniscus 40 works as the counter force. The varying diameter of the side chamber 30 causes the pressure on the meniscus 40 to become position dependent (Laplace pressure is inversely proportional to the radius of any meniscus). As a result, for each value of the current in the coil 19, there is a unique position of the meniscus 40.

At least a portion of the internal surface of the fluid chamber 12 is provided with a hydrophobic insulator. This would cover all of the internal surfaces of the fluid chamber 12, with the exception of the larger of the two end walls. The optical element 10 acts as a lens based upon meniscus displacement, where the displacement action is performed with a ferrofluid pump. If the coil 19 is actuated, the ferrofluid 22 is pulled into the coil 19, as illustrated by the arrow 42. This leads to a smaller radius of the meniscus 40 in the coil 19 and thus a larger repelling Laplace pressure. The hydrophobic insulator is used to reduce hysteresis.

A sixth embodiment of the optical element 10 is shown in FIG. 6, which is a variant of the embodiment of FIG. 5. The physical structure of the fluid chamber 12 in the optical element 10 is identical to that of the previous embodiment, and the position of the single coil 19 is unchanged with respect to that embodiment, number five. In this embodiment, the first fluid 20 is transparent and the second fluid (the ferrofluid) 22 is non-transparent (opaque). The fluid chamber also includes a third fluid 24, which is transparent and non-miscible with the ferrofluid 22 and the oil 20.

The optical element of FIG. 6 works in the same way as the previous embodiments, with the magnetic field created by the coil 19 causing the ferrofluid 22 to move and thereby affect the position of the meniscus that is acting as the lens in the main chamber 28 of the fluid chamber 12.

FIG. 7 shows a seventh embodiment of the optical element 10, with the lens in the main chamber 28 being formed by a double meniscus. The first fluid 20 in this embodiment is split into two portions, one at each end of the fluid chamber 12. The second fluid, the ferrofluid 22 is located in the side chamber 28, and as before acts as a pump to affect the position of the menisci in the main chamber 28, under the influence of the magnetic field created by the coil 19. The third fluid 24 is a liquid non-miscible with the ferrofluid 22 and with the oil 20.

In all of the embodiments above, the movement of the ferrofluid 22 causes a change in position of at least one meniscus between two fluids that lie on an optical path in the optical element. However it is possible to design the optical element in such a way that the meniscus that lies on the optical path is fixed in position. When this occurs, the movement of the ferrofluid, under the action of the magnetic field, will cause the meniscus to change shape, with a corresponding change in its optical characteristics. The shape of the interface between the two fluids is changed, either flattening or make rounder the meniscus.

The fixing of the meniscus to the sides of the fluid chamber of the optical element is achieved by having an abrupt change in the surface characteristics of the chamber. If one of the fluids on one side of the meniscus is water, and the other is in oil, then the fluid chamber will be coated with a hydrophilic substance, only on the portion that engages with the water. This will effectively maintain the water in position, pinning the meniscus to the sides of the fluid chamber at the point in the chamber at which the coating of the hydrophilic substance ends.

An optical element made according to any of the seven embodiments is suitable for use in an image capture device such as a camera, such as the one shown in FIG. 8. In this Figure, the back of a mobile telephone 60 is shown, with a camera 62. The camera 62 includes the optical element 10, which here is operating as a zoom lens. The optical element 10 has no mechanical moving parts and requires only a relatively low voltage for a short period of time to operate.

This leads to a highly effective and efficient lens that is suitable for use in situations where power consumption is of great importance. This is particularly the case in device such as mobile telephones that require substantial energy to power the display device and the wireless communication module of the mobile telephone.

1. An optical element comprising a fluid chamber (12), the fluid chamber (12) having side walls (14) and end walls (16), and containing a first fluid (20) and a second fluid (22), the fluids (20, 22) being non-miscible and the second fluid (22) being capable of being influenced by a magnetic field, and a device (18) for providing a magnetic field over at least a portion of the fluid chamber (12), the magnetic field capable of moving the second fluid (22) so that the positions of, and/or the shape of the interface between, the first and second fluids (20, 22) in the fluid chamber (12) are altered.

2. An optical element according to claim 1, wherein the fluid chamber (12) further contains a third fluid (24).

3. An optical element according to claim 1, wherein the or each contact surface between two different fluids (20, 22, 24) in the fluid chamber (12) forms a meniscus.

4. An optical element according to claim 3, wherein at least one fluid (24) contained in the fluid chamber (12) has two menisci.

5. An optical element according to claim 1, wherein the fluid chamber (12) comprises a main chamber (28) and a side chamber (30; 32).

6. An optical element according to claim 5, wherein the side chamber (30) is connected to the main chamber (28) at each end of the main chamber (28).

7. An optical element according to claim 1, wherein the device (18) for providing a magnetic field over at least a portion of the fluid chamber (12) comprises a voltage source (17) for generating a gradient magnetic field.

8. An optical element according to claim 7, wherein the device (18) for providing a magnetic field over at least a portion of the fluid chamber (12) includes a single coil (19).

9. An optical element according to claim 8, wherein the single coil (19) is around the side chamber of the fluid chamber (30; 32).

10. An optical element according to claim 7, wherein the device (18) for providing a magnetic field over at least a portion of the fluid chamber (12) includes a pair of coils (19).

11. An optical element according to claim 10, wherein at least one of the pair of coils (19) is around the side chamber (30; 32) of the fluid chamber (12).

12. An optical element according to claim 1, wherein the side walls (14) of the fluid chamber (12) are so shaped that the fluid chamber (12) comprises a substantially cylindrical shape.

13. An optical element according to claim 1, wherein the side walls (14) of the fluid chamber (12) are so shaped that the fluid chamber (12) comprises a substantially frustum shape.

14. An optical element according to claim 1, wherein the second fluid (22) is a ferrofluid (22).

15. An optical element according to claim 1, wherein the first fluid (20) and the second fluid (22) are transparent.

16. An optical element according to claim 1, wherein the first fluid (20) is transparent and the second fluid (22) is non-transparent.

17. An optical element according to claim 1, wherein at least a portion of the internal surface of the fluid chamber (12) is provided with a hydrophobic insulator.

18. An image capture device incorporating an optical element according to claim 1.

19. An optical recording device incorporating an optical element according to claim 1.
